(19) United States
(12) Patent Application Publication
(10) Pub. No.: US 2021/0114656 A1
(43) Pub. Date: Apr. 22, 2021

(54) TRACKED VEHICLE

(71) Applicants: Martin PAAL, Biberach an der Riss (DE); Klaus GRANER, Biberach an der Riss (DE)

(72) Inventors: Martin PAAL, Biberach an der Riss (DE); Klaus GRANER, Biberach an der Riss (DE)

(21) Appl. No.: 17/133,223

(22) Filed: Dec. 23, 2020

Related U.S. Application Data
(63) Continuation of application No. PCT/EP2019/067693, filed on Jul. 2, 2019.

(30) Foreign Application Priority Data
Jul. 3, 2018 (DE) 10 2018 116 077.1

(51) Int. Cl. B62D 11/00; B62D 11/04; B62D 11/08; F16H 37/06

(52) U.S. Cl. CPC B62D 11/003; B62D 11/04; B60W 50/029; F16H 37/065; B60W 2300/44; B62D 11/08

(57) ABSTRACT

The present invention relates to a tracked vehicle comprising at least two drivable crawler chains, a sensor device for detecting the actual speed of each of the at least two crawler chains, and a control device for controlling the driving speeds of the at least two crawler chains, wherein the control device includes a curve control module for adjusting different driving speeds for the at least two crawler chains for cornering in dependence on a steering signal of a steering signal transmitter. According to a first aspect it is proposed that with an individual drive of the at least two crawler chains the still operable other drive motor no longer follows the target rotational speed specified for the normal operation upon failure of a drive motor, but follows the sensorially detected chain or drive train speed of the failed drive by taking account of the steering signal and of the speed difference between the left and right chain sides, which is needed for the commanded curve.

### CROSS-REFERENCE TO RELATED APPLICATIONS

This application is a continuation of International Patent Application Number PCT/EP2019/067693 filed Jul. 2, 2019, which claims priority to German Patent Application Number DE 10 2018 116 077.1 filed Jul. 3, 2018, the contents of which are incorporated herein by reference in their entireties.

### BACKGROUND

The present invention relates to a tracked vehicle comprising at least two drivable crawler chains, a sensor device for detecting the actual speed of each of the at least two crawler chains, and a control device for controlling the driving speeds of the at least two crawler chains, wherein the control device includes a curve control module for adjusting different driving speeds for the at least two crawler chains for cornering in dependence on a steering signal of a steering signal transmitter.

Such tracked vehicles are known in various configurations and for example can be construction machines such as bulldozers or crawler excavators, or also form a snow groomer as it is used in ski areas. For driving round bends, the crawler chains are driven at different speeds in order to generate a speed difference between right and left crawler chains, which then leads to cornering. In general, both crawler chains still are driven in the same direction, i.e. either forwards or backwards, wherein it is also known in principle, however, to drive one crawler chain forwards and the other one backwards in order to rotate while standing, so to speak.

The crawler chains in principle can be driven in different ways. On the one hand, it is known to use a central drive motor whose drive movement is transmitted both to the right crawler chain and to the left crawler chain via a transmission. In order to be able to drive the sprockets of the right and left sides at different speeds despite a central drive motor, a so-called superimposed steering transmission can be used, which in essence comprises two planetary gear sets whose sun gears are driven at the same speed via the central drive shaft of the central drive motor, and whose planet carriers each are connected to the tumbler of the left and the right crawler chain, respectively. To be able to vary the rotational speeds of the two planet carriers against each other, the ring gears can be driven in mutually opposite directions from a steering drive, for example via a counter-rotating gear stage. Depending on the configuration, the connection of the central drive shaft, of the drive shafts connected to the tumblers, and of the steering drive can also be realized differently, for example, in such a way that the central output shaft of the central drive motor is coupled with the two ring gears, and the steering transmission rotates the sun gears in mutually opposite directions.

On the other hand, individual drives also have recently been used for the crawler chains, in which each crawler chain has its own drive motor, wherein each drive motor can be individually controllable or the two drive motors can be operated at different driving speeds so as to be able to drive the crawler chains at different speeds for driving round bends.

Such tracked vehicles are disclosed for example in the documents DE 10 2012 212 248 A1 and DE 10 2012 216 661 A1.

In such individual drives problems may arise as regards the steering system, when one of the two drives fails. Even if the other drive can be switched off relatively quickly, the curve radius specified by the steering system can no longer be maintained, as the vehicle would then run essentially straight ahead without drive. However, when the still functioning drive cannot be switched off quickly enough, this may lead to a completely uncontrolled cornering behavior.

Similar problems may occur with the central drive as described above. For example, when the steering drive fails so that the ring gears of the two planetary transmissions of the superimposed steering transmission no longer are driven in mutually opposite directions, the tracked vehicle in essence only can drive straight ahead. When the central drive fails, the reaction depends on the connection of the steering drive. When the steering drive is fed or supplied with energy from the central drive, the steering drive will also fail, and the tracked vehicle can only run straight ahead. On the other hand, when the steering drive has its own energy supply, uncontrolled turning of the tracked vehicle may occur, as the ring gears still are driven in mutually opposite directions.

Proceeding therefrom, it is the object underlying the present invention to create an improved tracked vehicle of the type mentioned above, which avoids that disadvantages of the prior art and develops the latter in an advantageous way. In particular, a stable steering behavior should be achieved also in a case of fault, when a drive fails.

### SUMMARY

According to the invention, said object is achieved by a tracked vehicle according to claim 1 and by a tracked vehicle according to claim 7. Preferred aspects of the invention are subject-matter of the dependent claims.

According to a first aspect it hence is proposed that with an individual drive of the at least two crawler chains the still operable other drive motor no longer follows the target rotational speed specified for the normal operation in the case of the failure of a drive motor, i.e. does not follow the target rotational speed specified for the error-free operation, but follows the sensorially detected chain or drive train speed of the failed drive by taking account of the steering signal and the resulting speed difference between the left and right chain sides, which is necessary for the possibly commanded curve. According to the invention, the curve control module of the control device for the individual drives of such a tracked vehicle has a failure control module for controlling the still operable drive of a crawler chain in the case of the failure of the drive of the other crawler chain, wherein said failure control module is configured to control the remaining drive in dependence on the actual speed of the crawler chain whose drive has failed, which is detected by the sensor device, and in dependence on the steering signal, in such a way that the at least two crawler chains have the different actual speeds needed for the steering signal. When the steering signal specifies a straight travel, the needed actual speeds of course are the same and the differential speed is zero.

Said failure control module which is activated upon failure of one of the individual drives hence no longer uses the target speed signal, which in normal operation can be calculated from the specified speed and the steering signal, for the actuation of the still operable drive, but uses the actual speed signal of the other, failed crawler chain and by taking account of the steering signal, but by ignoring the target speed which is specified by the travel speed selector lever, calculates a new actuation signal for the still operable drive in order to maintain the curve radius despite the non-driven other crawler chain, which curve radius corresponds to the specified steering signal and the driver's steering wish behind it, respectively.

Said sensor device, which detects the actual speeds of the at least two crawler chains, advantageously is designed redundantly in order to be able to also reliably detect the actual speed of each of the at least two crawler chains when the associated drive has failed.

The sensor device is able to detect the driving speeds of the at least two crawler chains at different points or elements. Advantageously, the sensor device can include speed sensors for detecting the actual rotational speed of a sprocket of each of the at least two crawler chains and/or speed sensors for detecting the actual rotational speed of the output side or shaft of each of the separate drives and/or speed sensors for detecting the actual rotational speed of a drive train transmission element between the tumbler of each crawler chain and the output shaft of each drive.

In principle, it would also be possible that the sensor device directly detects the running speed of the crawler chain, for example by a sensor comprising a feeler wheel running along the chain, or a contactless detection device for determining the running speed of the chain.

Said failure control module can actuate the still operable drive not only for cornering, but also for a straight travel in dependence on the actual rotational speed or speed signal of the failed crawler chain, when the steering signal specifies a straight travel.

Advantageously, said failure control module is configured in such a way that the steering signal, by means of which the still operable drive is actuated by taking account of the speed of the failed crawler chain, is updated continuously or cyclically in order to comply with a steering wish entered only after the failure of a drive. Hence, when the machine operator steers the tracked vehicle straight ahead at a time when one of the drives fails, said failure control module initially actuates the still operable drive in such away that the vehicle continues to drive straight ahead by taking account of the failed crawler chain. However, when the machine operator turns in, for example to avoid an obstacle, the failure control module takes account of the updated steering signal and tracks the current actual speed of the failed crawler chain with the still operable drive in such a way that the vehicle drives along a curve radius which corresponds to the steering wish.

To be able to not only continue to drive the still operable drive depending on the driving situation, for example driving uphill or downhill, but possibly also brake the still operable crawler chain in order to be able to maintain the desired straight travel or cornering, the still operable drive in accordance with an advantageous development of the invention can also advantageously be braked or provide a braking torque.

Advantageously, the individual drives can be configured as electric motors or comprise an electric motor, wherein to also provide a braking torque, it is advantageously possible to add a braking resistor for example in the form of a grid box, which can be initiated by said failure control module.

In principle, the drive motors however not only can be electric motors, but also can be configured as hydraulic motors which are supplied from a pressure source, for example from a pump.

In the case of electric drive motors it may be advantageous to provide each of the electric motors, which each drive one of the at least two crawler chains, with a converter, via which the respective motor can be actuated.

For supplying energy, the tracked vehicle can include a generator which can be driven by an internal combustion engine, for example a diesel engine, wherein in a development of the invention the current generated by the generator can be supplied to a rectifier which then can provide the current to each of said two converters.

A braking resistor can be connected to said rectifier in order to be able to brake as well or to generate a braking torque at the drive motor, which otherwise would be fed back to the generator, which in principle is also possible in order to be able to utilize the braking torque of the internal combustion engine.

When one of the two electric motors has failed, said braking resistor can be used even if it is also associated with the central rectifier and/or the braking power of the generator can be used for braking the still operable drive motor.

Nevertheless, it would also be possible alternatively or in addition to associate a separate braking resistor with each of the two or plurality of drive motors so that individual braking is possible.

Alternatively or in addition to regenerative braking via the drive motor, braking power can also be generated by a mechanical brake which advantageously can be actuated by said failure control module, if necessary, in order to provide the speed difference needed for cornering in the case of a failure of a drive motor. Advantageously, a mechanical braking device can be associated with each sprocket and/or the output shaft of each drive motor and/or an interposed drive train element in order to be able to generate a braking torque on each sprocket, if necessary. Advantageously, each of said braking devices can be actuated by the failure control module in order to be able to brake the sprocket of the failed drive and/or the sprocket of the still operable drive, if necessary, when a drive has failed. Advantageously, said failure control module actuates the respective braking device in dependence on the actual speed signal of the failed crawler chain and in dependence on the steering signal, in order to produce the necessary speed difference of the two crawler chains, wherein—in the case of a steering signal for straight travel—said speed difference can also be zero.

When using a central drive, which drives the at least two crawler chains via a superimposed steering transmission, there is also provided a failure control module according to another aspect of the present invention, which is activated upon failure of the steering drive or upon failure of the central drive and/or upon failure of the superimposed steering transmission and actuates at least one of the mechanical braking devices, which are provided for braking each crawler chain, in dependence on the actual speeds of the two crawler chains detected by the sensor device and in dependence on the steering signal in such a way that the crawler chains have the different actual speeds corresponding to the steering signal. For the case that the steering signal corresponds to a straight travel, the braking devices can of course also be actuated by said failure control module in such a way that the crawler chains have the same actual speeds.

In other words, in a case of fault, when the drive train breaks on one side or the steering drive fails, the brake of the drive of the still operable side and/or the brake on the failed side, in case the brake present there still works, hence is actuated in such a way that—still following the current steering command, the rotational speed of the sprocket of the operable side is adjusted in relation to the rotational speed of the sprocket on the faulty side in such a way as it is required for driving along the commanded curve—or possibly just straight ahead. The vehicle thereby remains steerable at any time and can safely be brought to a standstill with the usual braking functions.

Here as well, i.e. with such a central drive, the sensor device advantageously is configured redundantly in the described way and can include the rotational speed sensors likewise described already or also other sensors for speed detection.

The remaining configurations of the tracked vehicle explained already can analogously be provided in the central drive.

### BRIEF DESCRIPTION OF THE DRAWINGS

The invention will subsequently be explained in detail with reference to preferred exemplary embodiments and associated drawings. In the drawings:

FIG. 1: shows a schematic representation of a tracked vehicle comprising individual drives, which each include an independently actuatable electric motor for driving the tumbler of each crawler chain, and

FIG. 2: shows a schematic representation of the central drive of a tracked vehicle whose central drive motor drives the two tumblers of the two crawler chains via a superimposed steering transmission.

### DETAILED DESCRIPTION

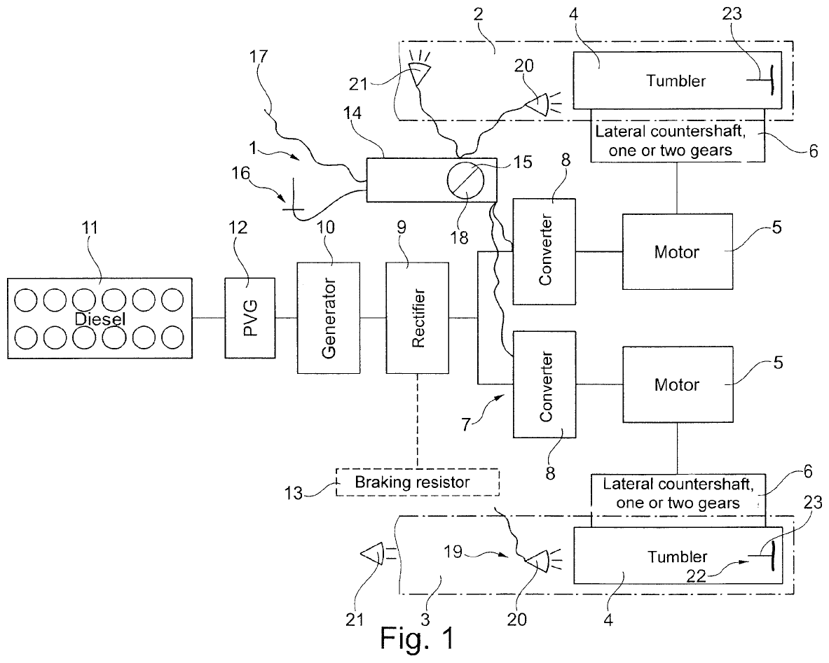

As shown in FIG. 1, the tracked vehicle 1 can include one crawler chain 2 and 3 each on the right and left of the vehicle body or chassis, which crawler chains can be guided so as to be endlessly circulating over a plurality of sprockets and together form the traveling gear of the tracked vehicle 1. The crawler chains 2, 3 can be configured differently depending on the type of the tracked vehicle, for example in the form of a steel link chain, a plastic and/or rubber profile chain or also a profile bar chain which is used for example to level ski slopes.

As is furthermore shown in FIG. 1, each of the crawler chains 2 and 3 is driven by a tumbler 4 which circumferentially engages with the inside of the respective crawler chain 2 and 3 and can rotatorily be driven about its axis of rotation, which can be arranged horizontally at right angles to the direction of travel.

FIG. 1 shows an individual drive in which each tumbler 4 can be driven by its own drive motor 5, wherein the output shaft of the drive motors 5 can be arranged coaxially to the tumbler axis or also offset therefrom in parallel, in particular when a transmission for example in the form of a countershaft transmission with one or two or also more gears is interposed between drive motor 5 and tumbler 4. As shown in FIG. 1, the two tumblers 4 of the two crawler chains 2 and 3 can be arranged coaxially to each other, wherein in this case the drive motors 5 advantageously can also be arranged coaxially to each other, in particular with the motor shafts aligned transversely to the direction of travel. In principle, however, it is also possible to arrange the tumblers 4 offset from each other in the direction of travel, in particular also when the crawler chains 2 and 3 are arranged at the same height in the direction of travel, for example due to the fact that the one tumbler 4 is arranged at the rear end of the one crawler chain and the other tumbler 4 is arranged at the front end of the other crawler chain.

Furthermore, it would also be possible to arrange the drive motors 5 with their motor shafts transversely to the drive axle of the tumblers 4, for example via an angled step at right angles to the drive axle or offset in parallel via a spur gear stage.

The drive motors 5 advantageously can be electric motors, wherein in principle, however, a hydraulic motor might also be considered, and mixed hybrid forms as well.

Advantageously, each of the drive motors 5 can be actuated individually and independently of the other drive motor 5 in order to be able to independently adjust the rotational speeds of the two tumblers 4 or vary the same against each other, and correspondingly drive the crawler chains 2 and 3 at different speeds.

As shown in FIG. 1, a separate actuation module 7 can be associated with each of the drive motors 5, which in case the drive motors 5 are configured as electric motors can each comprise a converter 8 which directs the current applied to the drive motors 5.

The two converters 8 can be fed from a rectifier 9 which supplies the current generated by a generator 10 to said converters 8.

Said generator 10 can be driven by an internal combustion engine, for example a diesel engine 11, for example directly or via a transmission for example in the form of a pump transfer gearbox 12.

As is furthermore shown in FIG. 1, the power supply circuit to which the electric motors 5 are connected furthermore can comprise a braking resistor 13, for example in the form of a grid box, in order to be able to brake the drive motors 5 and, in the generator mode of the drive motors 5, to be able to thermally decompose regenerative energy at said braking resistor 13. As explained already, a braking torque generated at the drive motors 5 for braking the same might also be supported via the generator 10 and the internal combustion engine 11 connected thereto.

The rotational speeds of the drive motors 5 can be varied against each other and be adjusted individually by the two converters 8, which in particular can be utilized for driving curves with the tracked vehicle 1 by one crawler chain circulating faster than the other crawler chain.

The electronic control device 14, which for example can comprise a microprocessor, a memory module with software deposited therein, and further hardware modules, therefor can actuate the power electronics to which the drive motors 5 are connected, in particular via said converters 8.

As shown in FIG. 1, said control device 14 can comprise a curve control module 15, which on its input side receives a steering signal from a steering device 16, via which a vehicle operator can enter his steering wish. Such a steering device can comprise a classical steering wheel, but also a joystick or other handlebar configurations. For example, the steering device 16 can include a steering angle detector which detects the lock angle of a steering wheel and provides a steering signal proportional to the lock angle, which then is processed by the curve control module 15 in order to generate corresponding, in particular different driving speeds at the drive motors 5 so that the crawler chains 2 and 3 move differently fast.

Furthermore, said control device 14 comprises a speed control module 17 which controls or regulates the driving speed of the tracked vehicle 1 and provides a driving speed signal to the power electronics, in particular to said converters 8, in order to operate the drive motors 5 with a corresponding torque and/or a corresponding speed. Said driving speed control module 17 can comprise a driving speed wish lever, for example in the form of an accelerator pedal or a joystick, in order to enable the vehicle operator to indicate a driving speed wish, depending on which—by taking account of the power reserves—the drive motors 5 then are actuated via said converter 8 and implement the driving speed wish.

In conjunction with the aforementioned curve control module 15, the speed control signal of the driving speed controller can be implemented as a basic control signal and upon entry of a curve or steering angle wish can then be modified for the right and left drive motors in order to adjust different chain speeds on the right and left while basically implementing the desired driving speed, which provides for cornering.

When one of the drive motors 5 fails, said control device 14 switches into a failure mode in which the actuation of the drive motors 5 is changed.

In particular upon failure of one of the drive motors 5, a failure control module 18 is activated, which can be part of the electronic control device 14 and actuates the still operable drive motor 5 in such a way that despite the failed drive motor, the desired curve radius is maintained or maintained as far as possible.

For this purpose, the tracked vehicle 1 comprises a redundantly designed sensor device 19 that detects the actual speed of each crawler chain 2 and 3, which can be accomplished directly or indirectly. For example, the sensor device 19 can comprise a pair of speed sensors 20 which detect the rotational speeds of the two tumblers 4 and/or the rotational speeds of the output shaft of the intermediate transmissions 6 in the form of the described lateral countershafts. Alternatively or in addition, said sensor device 19 can also comprise chain speed sensors 21 which detect the circulation speed of the crawler chains 2 and 3.

Hence, if one of the two drive motors 5 fails, said failure control module 18 actuates the still operable drive motor 5 in dependence on the detected actual speed of the other crawler chain, whose drive motor has failed, by taking account of the steering angle signal of the curve control module 15 or the steering device 16. In dependence on the measured actual speed of the crawler chain driven no longer, whose drive motor has failed, the circulation speed of the other crawler chain is tracked in such a way that the speed difference between the crawler chain driven no longer and the driven crawler chain leads to a curve radius which corresponds to the steering wish or said steering signal.

For this purpose, the drive motor 5 of the still operable side is actuated such that it —always following the current steering command —adjusts the rotational speed in relation to the faulty side, which is required to drive along the commanded curve —or possibly also straight ahead.

If braking of the still operable drive motor 5 is required to maintain the speed difference between the two crawler chains 2 and 3, which is necessary for cornering, said failure control module 18 can also provide regenerative braking, for example via said braking resistor 13.

The tracked vehicle 1 furthermore can also include a braking device 22 with mechanical brakes 23 for mechanically braking each of the crawler chains 2 and 3, wherein such mechanical brakes 23 for example can act on the drive shaft of the tumbler 4 or can also brake the tumbler 4 itself, wherein alternatively or in addition however a special, separate sprocket, which is in engagement with the respective crawler chain 2 or 3, can serve as braking wheel and can be braked.

If necessary, said failure control module 18 can make use of and actuate the braking device 22 in order to actuate at least one of the mechanical brakes 23 to ensure the speed difference needed for the commanded curve at the crawler chains 2 and 3.

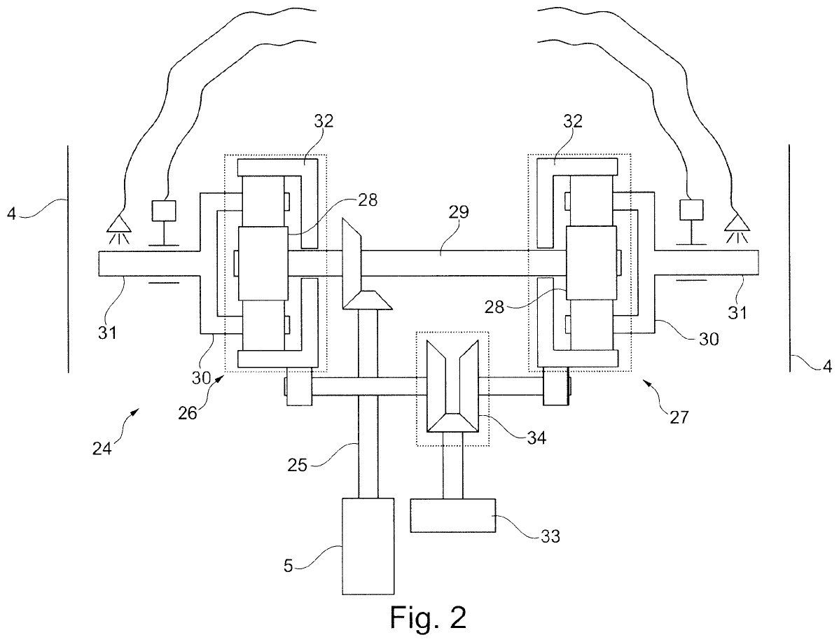

As shown in FIG. 2, the tracked vehicle 1 can also comprise a central drive in which a central drive motor 5 drives both tumblers 4. To split up or branch the rotatory drive movement of the drive motor 5 for both tumblers 4, a superimposed steering transmission 24 can be provided, which can include a central input shaft 25 which is driven by the drive motor 5, cf. FIG. 2.

Such a superimposed steering transmission 24 can comprise two planetary gear sets 26, 27, whose sun gears 28 advantageously can be driven coaxially to each other and can be synchronized by a common drive shaft 29, cf. FIG. 2, wherein said drive shaft 29 and hence both sun gears 28 can be driven by the drive motor 5.

Each of the planet carriers 30 of the planetary gear sets 26 and 27 can drive the tumbler 4 of the right and left crawler chains 2 and 3, respectively, via one output shaft 31 each, cf. FIG. 2.

To be able to vary the driving speeds of the left and right crawler chains 2 and 3 against each other despite the central drive motor, it is provided to drive the two ring gears 32 of the planetary transmissions in mutually opposite directions, namely by a steering drive 33 which is actuated in dependence on said steering signal and is able to rotate the ring gears 32 in mutually opposite directions via a counter-rotating gear stage 34, cf. FIG. 2.

If one drive side fails, for example due to breakage of the planet carrier, or if the steering drive 33 fails, so that the tracked vehicle 1 no longer would maintain a specified curve radius, the above-mentioned failure control module is activated in order to replace or modify the “normal” actuation of the central drive motor 5 and of the steering drive 33 and to ensure cornering in a failure operating mode. For this purpose, said failure control module actuates the braking device 22 and actuates at least one of the two mechanical brakes 23 in order to ensure the speed difference of the two tumblers 4 required for the specified steering signal and the correspondingly desired curve radius. As shown in FIG. 2, the two brakes 23 can act for example on the output shaft 29 which connects the planetary transmissions 26 and 27 to the two tumblers 4.

The actuation of the braking device 22 here is effected, in conjunction with said steering signal, in dependence on the actual speeds of the two crawler chains 2 and 3 detected by the sensor device 19, wherein here for example speed sensors 20 can detect the rotational speeds of the two tumblers 4 or of said output shafts 31, cf. FIG. 2.

We claim:

1. A tracked vehicle comprising:
at least two crawler chains each configured to be driven by at least one separate drive;
a sensor device configured to detect the actual speed of each of the at least two crawler chains;
at least one control device configured to control the driving speed of the drives, wherein the control device comprises a curve control module configured to adjust different driving speeds for the at least two crawler chains for cornering in dependence on a steering signal of a steering signal transmitter,
wherein the curve control module comprises a failure control module configured to control a first drive of a first crawler chain upon failure of a second drive of a second crawler chain, wherein the failure control module is configured to control the first drive in dependence on the actual speed of the second crawler chain, and to control the actual speed of the second crawler chain in dependence on the steering signal in such a way that the crawler chains have the differential speed each required for the steering signal.

2. The vehicle of claim 1, wherein the sensor device comprises speed sensors configured to detect the actual rotational speed of a sprocket of each of the at least two crawler chains and/or the driving speed of the drives.

3. The vehicle of claim 1, wherein the drives each comprise an electric drive motor, and wherein the drive motors are each configured to be actuated by a separate converter, wherein the converters are configured to be actuated individually by the curve control module and a failure control module of the curve control module.

4. The vehicle of claim 1, wherein the curve control module is configured to take account of a driving speed signal of a driving speed controller and/or control module and actuate the converters in dependence on the driving speed signal when the first and second drives are operable, while the failure control module is configured to ignore the driving speed signal for the actuation of the converter of the first drive upon failure of the second drive, and observe the actual speed signal of the sensor device.

5. The vehicle of claim 1, wherein the drives are configured to be supplied with electric energy by a generator configured to be driven by an internal combustion engine, wherein the curve control module and/or the failure control module is/are configured to brake the first drive upon failure of the second drive, and operate the first drive by a generator, wherein a braking resistor in the power supply circuit between at least one of the drives and the generator and/or via the generator on the internal combustion engine is configured to support a regenerative current.

6. The vehicle of claim 1, wherein a braking device comprising a mechanical brake for each of the crawler chains is associated with the two crawler chains, wherein the mechanical brakes are configured to be actuated by the failure control module upon failure of a drive in dependence on the measured actual speeds of the two crawler chains and in dependence on the steering signal.

7. A tracked vehicle comprising:
at least two crawler chains configured to be driven by a central drive via a superimposed steering transmission comprising two planetary gear sets comprising two first sun gears synchronized with each other and configured to be driven by the central drive, and wherein the transmission comprises a planet carrier in drive connection with a sprocket of one of the crawler chains, and wherein the transmission comprises ring gears configured to be driven in mutually opposite directions by a steering drive, further comprising a control device configured to control the drive speed of the central drive and a curve control module for actuating the steering drive in dependence on a steering signal of a steering signal transmitter, further comprising a braking device comprising one mechanical brake each for each of the crawler chains, wherein the curve control module comprises a failure control module configured to actuate the braking device upon failure of the steering drive and/or upon failure of a drive side of the superimposed steering transmission, wherein the failure control module is configured to actuate at least one of the mechanical brakes in dependence on the actual speed of at least one of the two crawler chains detected by the sensor device, and in dependence on the steering signal such that the crawler chains have the different actual speeds required for the steering signal.

8. The vehicle of claim 7, wherein the failure control module is configured to actuate the mechanical brake of at least one of the at least two crawler chains such that the actual speeds detected for the crawler chains in relation to each other correspond to the steering signal.
